(19) United States
(12) Patent Application Publication
(10) Pub. No.: US 2004/0199379 A1
(43) Pub. Date: Oct. 7, 2004

(54) Method for employing interference canceling with predetection combiners

(76) Inventor: Charles Bert Hickman, Palmdale, CA (US)

Correspondence Address: CHARLES BERT HICKMAN, 3817 SOUTHVIEW COURT, PALMDALE, CA, 93550, US

(21) Appl. No.: 10/406,087

(22) Filed: Apr. 4, 2003

(51) Int. Cl. G10L 19/00

(52) U.S. Cl. 704/201

(57) ABSTRACT

Predetection combiners when properly implemented tend to function very well in combining diversity signals. However, they do not fair very well under some cases of interference sources (e.g. jamming). A novel method for using adaptive signal processing for interference canceling with a predetection combiner is disclosed.

### BACKGROUND OF THE INVENTION

This patent relates to adaptive signal processing and diversity combining. Predetection combiners when properly implemented tend to function very well in combining diversity signals. However, they do not fair very well under some cases of interference sources (e.g. military jamming). On the other hand, adaptive beamformers tend to handle these interference conditions better. However, they tend not to be as good a diversity combiner under some conditions. It is desired to have the combining advantages of the predetection combiner with the interference handle abilities of the adaptive signal processor.

FIG. 1 depicts the general topology for a class of adaptive signal processors for diversity signal inputs (derived from “Adaptive Signal Processing” FIG. 14.4, by Bernard Widrow and Samuel D. Stearns, Prentice-Hall Inc., 1985). The first diversity input signal 200 is sent to delay function 100 which produces delayed signal 215. The second diversity input signal 205 is sent to delay function 110 which produces delayed signal 220. The last diversity input signal 210 is sent to delay function 120 which produces delayed signal 225 (other diversity inputs would be delayed in like manner). These delays 100, 110, 120 are selected such that their signal outputs 215, 220, 225 are in phase for the desired signal component that is to be demodulated. Collectively these delays 100, 110, 120 form what is oftentimes called the “look direction” of the array. These delayed signals 215, 220, 225 are added together within summer 130 to produce combined signal 230.

The summed signal 230 goes to optional filter 140 which produces filtered signal 235. Additionally, the delayed signals 215, 220, 225 are, also, sent to adaptive interference processor 160 which produces processed signal 245. This processed signal 245 is then subtracted from the filtered signal 235 within adjustment summer 150 to produce the interference adjusted output signal 240. This interference adjusted output signal 240 is the error signal that is sent to adaptive interference processor 160 for tap weight adjustments for interference removal. It is an objective of the present invention to replace the delays 100, 110, 120 and the summer 130 with a predetection combiner.

### BRIEF SUMMARY OF THE INVENTION

The present invention takes a plurality of diversity signal inputs into a predetection combiner which phase aligns and then combines them into a single signal. Additionally, within the predetection combiner these phase aligned signals are sensed prior to combining and sent to an adaptive interference processor. The predetection combined signal is passed through an optional filter. The signal from the filter is sent to an adjustment summer wherein the signal from the adaptive interference processor is subtracted from it. The signal from this adjustment summer is the interference adjusted output signal; this output signal is also sent to the adaptive interference processor as an error input signal.

### BRIEF DESCRIPTION OF THE DRAWINGS

FIG. 1 depicts a class (prior art) of adaptive signal processors for diversity signals for interference cancellation.

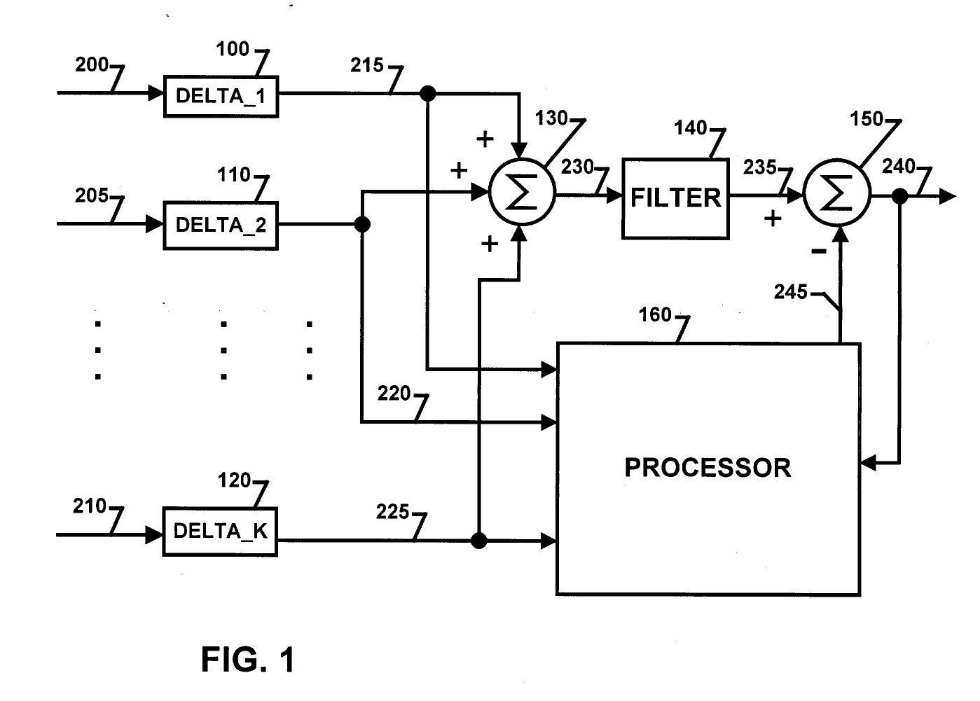

FIG. 2 depicts the present invention that combines an adaptive interference processor with a predetection combiner.

FIG. 3 depicts an alternate embodiment of the present invention that combines an adaptive interference processor with a modified predetection combiner.

### DETAILED DESCRIPTION OF THE INVENTION

A novel method for using adaptive signal processing interference canceling with a predetection combiner is disclosed. In the following description for purposes of explanation, numerous details are set forward to provide a through understanding of the present invention. However, it will be apparent to one ordinarily skilled in the art that these details are not required in order to practice the invention. It should be noted that the present invention contains understandable variations of Widrow's FIG. 14.4 (“Adaptive Signal Processing” as above) with Widrow's associated detailed examples and explanations throughout; therefore, it should be apparent to one ordinarily skilled in the art as to how the present invention can be implemented. Extensive details related to adaptive signal processing and predetection combining are not presented herein, because adequate literature exists for these subjects. Herein, a plurality of diversity input signals shall be construed to be more than one.

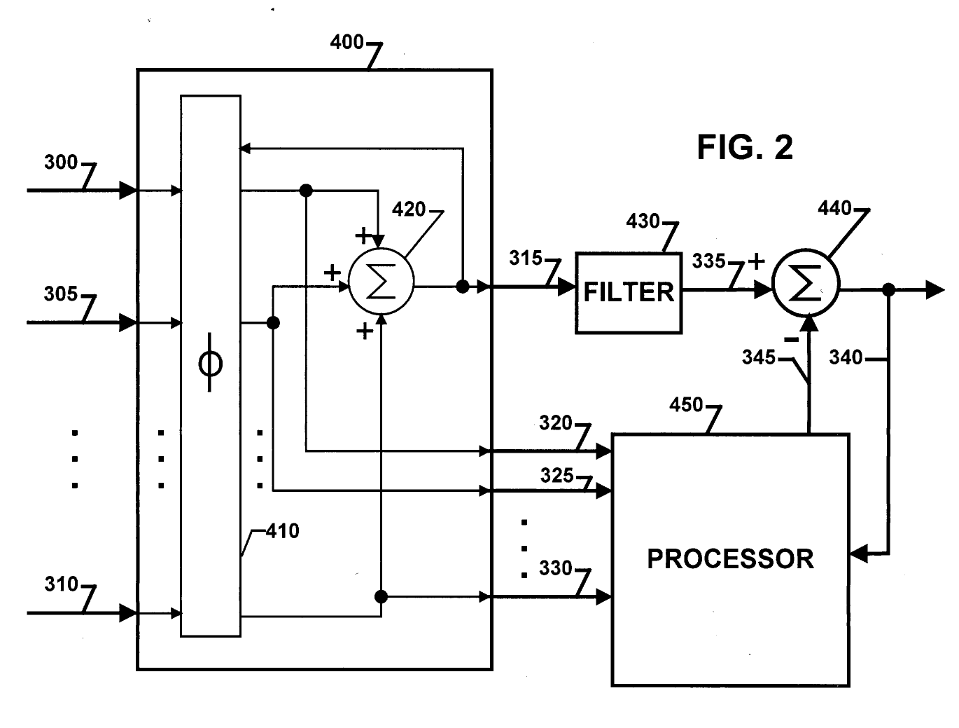

FIG. 2 depicts a preferred embodiment of the present invention. It consists of a predetection combiner 400, an adaptive interference processor 450, an optional filter 430, and an adjustment summer 440. The diversity input signals 300, 305, 310 are received by the predetection combiner 400; it is preferred that the predetection combiner 400 be of the equal-gain type. These diversity signals 300, 305, 310 could be either RF or IF type signals; oftentimes they are IF types. In cases where different RF frequencies are involved (e.g. frequency diversity, frequency-hop, . . . ) one would usually prefer to use IF type for diversity signals 300, 305, 310. It is preferred that the present invention be employed in frequency-hop applications. These diversity signals 300, 305, 310 first are processed by a phase alignment function 410 which produces phase aligned signals 320, 325, 330 (herein aligned, phase aligned, . . . refer to the desired modulated signal frequency). These phase aligned signals 320, 325, 330 are sent to detection summer 420 and adaptive interference processor 450. These phase aligned signals 320, 325, 330 are added together within detection summer 420 to produce the combined signal 315. This combined signal 315 is fed back to the phase alignment function 410 which derives a reference phase for alignment; also, it 315 is also fed to an optional filter 430.

This filter 430 could be in accordance with Widrow's FIG. 14.4 explanation, but it is not so constrained. This filter 430 produces a filtered signal 335 that is sent to adjustment summer 440. Adjustment summer 440 takes the adaptive interference processor 450 processed signal 345 and subtracts it from the filtered signal 335 to produce the interference adjusted output signal 340. The interference adjusted output signal 340 is also fed to the adaptive interference processor 450 as an error signal for tap weight adjustments. In general the adaptive interference processor 450 takes the phase aligned signals 320, 325, 330 and removes the bulk of the desired signal while retaining the interference signal(s). Then it can us any number of adaptive algorithms (e.g. LMS algorithm) to correlate the interference adjusted output signal 340 with these interference signal(s) to determine the tap weigh adjustment that determine the value of the processed signal 345.

The predetection combiner has another advantage in that it allows a variable “look direction” when the direction of the incoming signal is not know (e.g. there is relative motion between the transmitter(s) and the diversity array-mobile situations). The predetection combiner also has the advantage of performing better than some adaptive signal processors in the absence of any significant external interference signal(s). It should be noted that in the case where optional filter 430 is not used, processed signal 345 is then subtracted from combined signal 315 within adjustment summer 440.

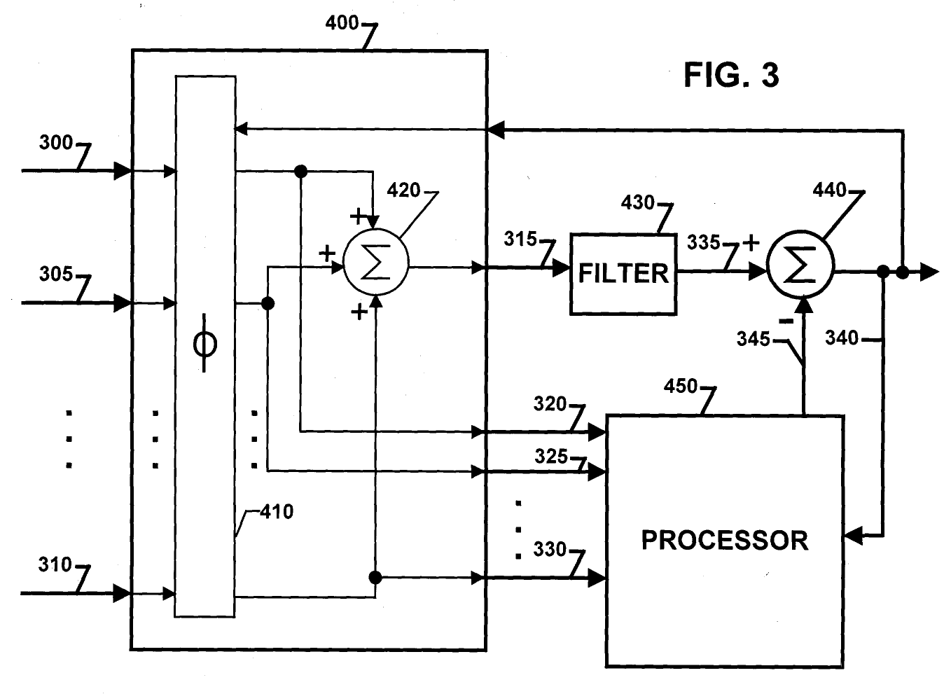

FIG. 3 depicts an alternate embodiment of the present invention where in the predetection combiner is modified such that the feedback to the phase alignment function 410 is taken from the interference adjusted signal 340 instead of the combined signal 315.

What is claimed is:

1. Method for employing interference canceling with a predetection combiner including the steps of:
A) receiving a plurality of diversity input signals;
B) combining said plurality of input signals within a predetection combiner which produces a combined signal;
C) subtracting a processed signal from said combined signal within an adjustment summer to produce an adjusted output signal;
D) sending said adjusted output signal as an error signal to an adaptive interference processor;
E) additionally, sending phase aligned signals from within said predetection combiner to said adaptive interference processor to produce said processed signal.

2. Method of claim 1 further including the step of filtering said combined signal prior to sending it to said adjustment summer.

3. Method for employing interference canceling with a modified predetection combiner including the steps of:
A) receiving a plurality of diversity input signals;
B) combining said plurality of input signals within a modified predetection combiner which takes an external feedback input and produces a combined signal;
C) subtracting a processed signal from said combined signal within an adjustment summer to produce an adjusted output signal;
D) sending said adjusted output signal to said external feedback input of said modified predetection combiner;
E) sending said adjusted output signal as an error signal to an adaptive interference processor;
F) additionally, sending phase aligned signals from within said modified predetection combiner to said adaptive interference processor to produce said processed signal.

4. Method of claim 3 further including the step of filtering said combined signal prior to sending it to said adjustment summer.
